(19) United States
(12) Patent Application Publication
(10) Pub. No.: US 2025/0119217 A1
(43) Pub. Date: Apr. 10, 2025

(54) SYSTEM FOR STRUCTURE-BORNE SOUND COMMUNICATION WITHIN THE SYSTEM

(71) Applicant: Robert Bosch GmbH, Stuttgart (DE)

(72) Inventors: Lukas Grinewitschus, Reutlingen (DE); Dominik Neeser, Reutlingen (DE)

(21) Appl. No.: 18/905,887

(22) Filed: Oct. 3, 2024

(30) Foreign Application Priority Data
Oct. 10, 2023 (DE) 10 2023 209 881.4

(51) Int. Cl. H04B 11/00

(52) U.S. Cl. CPC H04B 11/00

(57) ABSTRACT

A system for structure-borne sound communication within the system. The system includes a first electronic device and a second electronic device, wherein the first electronic device includes at least a first processing unit and a first structure-borne sound actuator, wherein the first processing unit is configured to emit a first structure-borne sound signal by means of the first structure-borne sound actuator, and wherein the second electronic device includes at least a second processing unit and a second structure-borne sound sensor, wherein the second processing unit is configured to detect a structure-borne sound signal by means of the second structure-borne sound sensor and, depending on the detected structure-borne sound signal, to determine whether a mechanical connection is present between the first electronic device and the second electronic device.

### BACKGROUND INFORMATION

Systems that use structure-borne sound for communication within the system are described in the related art. However, these systems typically have a central control unit that serves as a node for the communication between the individual electronic devices of the system. In addition, with corresponding systems, active participation of the user is typically required in order to initiate communication and also to support or confirm the establishment of communication. This makes such systems from the related art extremely complex and expensive, and the requirement for active user participation is not user-friendly.

The aforementioned problems in the related art are to be solved by means of the present invention.

### SUMMARY

The present invention relates to a system for structure-borne sound communication within the system. According to an example embodiment of the present invention, the system comprises a first electronic device and a second electronic device, wherein the first electronic device comprises at least a first processing unit and a first structure-borne sound actuator, wherein the first processing unit is configured to emit a first structure-borne sound signal by means of the first structure-borne sound actuator, and wherein the second electronic device comprises at least a second processing unit and a second structure-borne sound sensor, wherein the second processing unit is configured to detect a structure-borne sound signal by means of the second structure-borne sound sensor and, depending on the detected structure-borne sound signal, to determine whether a mechanical connection is present between the first electronic device and the second electronic device.

An advantage here is that the electronic devices of the system do not have to communicate via another electronic device, but can communicate directly with one another without a node, as a result of which the structure of the system can be kept as simple and cost-effective as possible. Furthermore, the system according to the present invention does not necessarily require any active action on the part of the user, since the communication between the electronic devices can be automated accordingly, as a result of which the process is extremely user-friendly.

The communication via structure-borne sound can thus be used in order to decide which devices “belong” to one another, or which devices have a connection to one another via a solid medium. This can be used, for example, to check whether a smartphone and a laptop are on the same table or whether a headset is in the associated charging case.

Structure-borne sound communication is signal transmission by means of sound waves, which takes place via a solid transmission medium. The transmission medium may be a table top or a door, for example. However, it is also possible that the electronic devices are arranged directly on one another without such an additional intermediate medium, wherein the structure-borne sound can, for example, be transmitted from one device to the other device via the housings of the electronic devices as the solid medium. Here, the structure-borne sound signal can have a frequency range from a few Hz to 100 kHz, wherein the preferred frequency range is below a few kHz.

According to an example embodiment of the present invention, an electronic device is a user-manageable functional unit that contains one or more electronic circuits as an essential component and is typically accommodated in a housing. Such an electronic unit may, for example, be a cell phone, a laptop, a keyboard, a mouse, an electronic lock, or even a headset. Consequently, structure-borne sound communication may, for example, take place between a cell phone and a laptop or between a mouse and a laptop or between a cell phone and an electronic lock.

The processing unit may, for example, be designed as a microcontroller. In particular, the microcontroller may be configured to exchange data with a memory unit and to carry out arithmetic operations. Here, the memory unit can be arranged externally of the microcontroller in the associated electronic device, but it is also possible to integrate the memory unit into the microcontroller.

The structure-borne sound actuator may, for example, be a loudspeaker, in particular a MEMS loudspeaker, but may also be any other type of motor, rotor or actuator that can specifically generate structure-borne sound signals.

According to an example embodiment of the present invention, the structure-borne sound sensor may, for example, be an acceleration sensor that is configured to detect accelerations resulting from structure-borne sound signals. However, it is also possible that the structure-borne sound sensor is designed as a rotation rate sensor or structure-borne sound microphone.

Other types of sensors for detecting the structure-borne sound signal are also possible.

A mechanical connection is a direct physical connection between the electronic devices or an indirect physical connection via a solid medium, e.g., a table top. This means that it is not sufficient when the electronic devices are only in close proximity to one another, for example one device in a user's pocket and the other device on a table at which the user is sitting. This is an advantage over wireless communication in terms of the security of possible authentication between the electronic devices.

One example embodiment of the present invention provides that the second processing unit is configured to determine that a mechanical connection is present, if the detected structure-borne sound signal is substantially the emitted first structure-borne sound signal.

An advantage here is that this is a simple way of checking whether the structure-borne sound signal detected by the second electronic device was emitted by the first electronic device, by assuming that this is the case if the emitted and received structure-borne sound signals are almost identical. If this is the case, it can in turn be determined accordingly that there must be a mechanical connection between the two electronic devices. Consequently, it is checked here whether the detected structure-borne sound signal has the signature of the first structure-borne sound signal.

One example embodiment of the present invention provides that the first processing unit is configured to emit the first structure-borne sound signal with at least one predetermined property, in particular a frequency range and/or an amplitude range and/or a bit sequence, wherein the second processing unit is configured to determine that a mechanical connection is present, if the detected structure-borne sound signal substantially has the predetermined property of the emitted first structure-borne sound signal or only has a deviation in the property that is less than a specified maximum deviation.

An advantage here is that this is another simple way of confirming that the structure-borne sound signal detected by the second electronic device was emitted by the first electronic device and that there must thus be a mechanical connection between the two electronic devices. In particular, it can be taken into account here that the structure-borne sound signal emitted by the first electronic device can change during the transmission and that, for example, the structure-borne sound signal, upon detection of the second electronic device, has undergone a slight frequency shift or amplitude reduction in comparison to the structure-borne sound signal originally emitted by the first electronic device. This change in the structure-borne sound signal on the way from the source to the receiving target can be caused, for example, by corresponding attenuating properties of the transmission medium or by external interference signals.

According to a further example embodiment of the present invention, it is provided that the first processing unit and the second processing unit are configured to carry out channel equalization for structure-borne sound communication, in particular by means of an adaptive filter.

An advantage here is that the channel equalization can also correct major changes in the structure-borne sound signal on the way from the source to the receiving target.

Such channel equalization may, for example, be carried out with a preamble and/or midamble known for both devices, for example by means of the so-called OSI reference model, in which the actual signal transmission is carried out in the physical layer. Applications such as comparing the numerical code of a radio signal may also be carried out at higher levels. In this case, it is not necessary for the deviation between the emitted and received structure-borne sound signal in the physical layer to be less than a specified maximum deviation.

A further example embodiment of the present invention provides that the first electronic device comprises a motion sensor and/or an operating element, wherein the first processing unit is configured to detect a motion of the first electronic device by means of the motion sensor and to emit the first structure-borne sound signal if a motion is detected, and/or to detect an operating signal by means of the operating element and to emit the first structure-borne sound signal if an operating signal is detected.

An advantage here is that the first structure-borne sound does not have to be sent continuously in order to check for a possible mechanical connection, but only as required. Thus, upon the motion of the first device, it can be concluded that a user may have moved it and wants to use it accordingly. Alternatively or additionally, the emission of the first structure-borne sound signal can be specifically influenced by the user by controlling the emission by actuating the operating element. These two options serve, among other things, to reduce the energy consumption of the first electronic device.

The motion sensor may, for example, be designed as an acceleration sensor and/or a rotation rate sensor.

The operating element may, for example, be designed as a button or a knob or as a touchscreen of the electronic device. The operating signal can therefore be generated by pressing a button or making a selection on the laptop screen.

According to a further embodiment of the present invention, it is provided that the first processing unit is configured to add at least one piece of information to the first structure-borne sound signal, wherein the second processing unit is configured to evaluate the information of the detected first structure-borne sound signal upon detection of the first structure-borne sound signal.

An advantage here is that the information can be used to implement additional functions within the system. These functions may mean, for example, unlocking or coupling of the electronic devices. Alternatively, the information may also contain properties of the first device, which can be processed accordingly by the second device. In particular, the second device can implement a corresponding response on the basis of the information received from the first device. For example, if the first device is a wireless headset and the second device is a charging case for this headset, the information sent from the headset to the charging case via structure-borne sound can include the charging state of the headset. Depending on the charging state received, the charging case can then, for example, set charging parameters for charging the headset accordingly.

According to a further embodiment of the present invention, it is provided that a specified password is stored in the first electronic device and in the second electronic device in each case, wherein, in addition, a public key of a key pair is stored in the first electronic device and a private key of the key pair is stored in the second electronic device, wherein the first processing unit is configured to encrypt the specified password with the public key of the key pair and to add the encrypted password as information to the first structure-borne sound signal, and wherein the second processing unit is configured, upon detection of the first structure-borne sound signal, to decrypt the encrypted password with the private key of the key pair and to compare the decrypted password to the password specified in the second electronic device, and wherein the second processing unit is configured to unlock the second electronic device if the decrypted password and the specified password match.

An advantage here is that unidirectional communication from the first device to the second device is made possible by means of structure-borne sound. This communication can be used accordingly to unlock the second device if the first device has a mechanical connection to the second device, provided that the first and second devices have been configured accordingly. Here, the first electronic device may, for example, be a smartphone, and the second electronic device may be a laptop or a computer that belongs to the same user and is to be unlocked with the aid of the smartphone.

The key pair consisting of a public and private key can be used in the sense of asymmetric cryptography in order to make corresponding authentication possible between the electronic devices.

Unlocking can be understood as the removal of an electronic lock. Such a lock is used, for example, on a laptop or cell phone to prevent unauthorized persons from accessing the corresponding device. However, unlocking may also lead to the electronic lock of a door being opened, for example.

The recognition as to whether two electronic devices are connected to one another via a solid medium can therefore be used, for example, for a user to unlock their notebook or tablet computer with their smartphone by simply placing the smartphone on the table on which the laptop is located or by placing their smartphone on the laptop itself.

According to a further embodiment of the present invention, it is provided that the first processing unit is configured to additionally add a first, current time stamp as information to the first structure-borne sound signal, and wherein the second processing unit is configured to additionally compare the received first time stamp to a second, current time stamp upon detection of the first structure-borne sound signal, and wherein the second processing unit is configured to unlock the second electronic device if, in addition, the difference between the first time stamp and the second time stamp is less than a specified threshold value.

An advantage here is that the time stamp can be added in order to prevent or at least make it more difficult to carry out so-called replay attacks. As a result, the security of the unlocking process can be increased further.

According to a further embodiment of the present invention, it is provided that the first electronic device comprises a first structure-borne sound sensor and the second electronic device comprises a second structure-borne sound actuator, and wherein, in addition, a public key of a key pair is stored in the first electronic device and a private key of the key pair is stored in the second electronic device, and wherein the second processing unit is configured, after determining that a mechanical connection is present between the first device and the second device, to generate a random bit sequence and to emit by means of the second structure-borne sound actuator a second structure-borne sound signal, to which the randomly generated bit sequence has been added as information, and wherein the first processing unit is configured to detect the second structure-borne sound signal by means of the first structure-borne sound sensor, to encrypt with the public key the bit sequence contained in the second structure-borne sound signal, and to emit by means of the first structure-borne sound actuator a third structure-borne sound signal, to which the encrypted bit sequence has been added as information, and wherein the second processing unit is configured to detect the third structure-borne sound signal by means of the second structure-borne sound sensor, and to decrypt the encrypted bit sequence with the private key of the key pair, and to compare the decrypted bit sequence to the generated bit sequence, and wherein the second processing unit is configured to unlock the second electronic device if the decrypted bit sequence and the randomly generated bit sequence match.

An advantage here is that bidirectional communication between the first electronic device and the second electronic device is made possible by means of structure-borne sound. This communication can be used accordingly to unlock the second device if the first device has a mechanical connection to the second device, provided that the first and second devices have been configured accordingly. Here, the first electronic device may, for example, be a smartphone, and the second electronic device may be a laptop or a computer that belongs to the same user and is to be unlocked with the aid of the smartphone.

According to one example embodiment of the present invention, it is provided that the first processing unit is configured to additionally add a first, current time stamp as information to the third structure-borne sound signal, and wherein the second processing unit is configured to additionally compare the received first time stamp to a second, current time stamp, and wherein the second processing unit is configured to unlock the second electronic device if, in addition, the difference between the first time stamp and the second time stamp is less than a specified threshold value.

An advantage here is that the time stamp can be added in order to prevent or at least make it more difficult to carry out so-called replay attacks. As a result, the security of the unlocking process can be increased further.

According to one example embodiment of the present invention, it is provided that the first electronic device comprises a first radio module and the second electronic device comprises a second radio module, wherein the first processing unit is configured to add a coupling request and the radio module address of the first radio module as information to the first structure-borne sound signal, and wherein the second processing unit is configured, upon detection of the first structure-borne sound signal, to recognize the coupling request, to emit to the radio module address of the first radio module by means of the second radio module a first radio signal, which in turn contains a coupling request as information, and also to calculate a second pairing key, and wherein the first processing unit is configured to detect the first radio signal by means of the first radio module and, depending thereon, to calculate a first pairing key and to emit by means of the first structure-borne sound actuator a second structure-borne sound signal, to which the first pairing key has been added as information, and wherein the second processing unit is configured to detect the second structure-borne sound signal and, upon detection of the second structure-borne sound signal, to compare the first pairing key to the second pairing key and, if they match, to emit by means of the second radio module a second radio signal, which confirms the coupling request of the first electronic device.

An advantage here is that unidirectional structure-borne sound communication from the first device to the second device can be used to make radio coupling possible between the first device and the second device if the first device has a mechanical connection to the second device. For this purpose, a corresponding method from the related art can be used to calculate the pairing keys. Consequently, pairing via Bluetooth or another radio interface can be simplified. Until now, for example, Bluetooth has required a user to check a six-digit numerical code in order to confirm that two devices belong together. This check can be simplified by the present invention.

Here, the first electronic device may, for example, be a keyboard or a mouse, and the second electronic device may be a laptop or a computer that is to be connected wirelessly to the first device so that it can be controlled by the first device.

The corresponding radio modules may, for example, be designed as a Bluetooth and/or WLAN module. Accordingly, the radio signals are Bluetooth and/or WLAN signals. A coupling request can be understood here as part of the authentication process for the radio modules so that they can exchange corresponding data after successful coupling, which is also referred to as pairing.

In particular, it is also possible not to carry out pairing yet, but only to discover potential devices suitable for pairing. For this purpose, the first device sends out the first structure-borne sound signal, in response to which all second devices that have a mechanical connection to the first device send back a second structure-borne sound signal in order to “report” to the first device. This information can then be stored in the first device. The first device can thereupon automatically establish a coupling with all available devices, or a user can actively decide with which of the available devices a coupling is to be established. It is also possible that the first device will make the discovered devices available to the user in a kind of list for a better overview. For example, all devices that are accessible via radio are displayed to the user, wherein devices that also have a mechanical connection are highlighted separately.

According to one example embodiment of the present invention, it is provided that the first electronic device comprises a first structure-borne sound sensor and a first radio module and the second electronic device comprises a second structure-borne sound actuator and a second radio module, wherein the first processing unit is configured to add a first coupling request as information to the first structure-borne sound signal, and wherein the second processing unit is configured, upon detection of the first structure-borne sound signal, to recognize the first coupling request and, depending thereon, to emit by means of the second structure-borne sound actuator a second structure-borne sound signal, which contains the radio module address of the second radio module as information, and wherein the first processing unit is configured to detect the second structure-borne sound signal by means of the first structure-borne sound sensor and, upon detection of the second structure-borne sound signal, to emit to the radio module address of the second radio module by means of the first radio module a first radio signal, which contains a second coupling request as information, and also to calculate a first pairing key, and to emit by means of the first structure-borne sound actuator a third structure-borne sound signal, which contains the first pairing key as information, and wherein the second processing unit is configured to detect the first radio signal by means of the second radio module and, depending thereon, to calculate a second pairing key and to detect the third structure-borne sound signal and, upon detection of the third structure-borne sound signal, to compare the first pairing key to the second pairing key and, if they match, to emit by means of the second radio module a second radio signal, which confirms the second coupling request of the first electronic device.

An advantage here is that bidirectional structure-borne sound communication between the first device and the second device can be used in order to make radio coupling possible between the first device and the second device if the first device has a mechanical connection to the second device. For this purpose, a corresponding method from the related art can be used to calculate the pairing keys. Here, the first electronic device may, for example, be a keyboard or a mouse, and the second electronic device may be a laptop or a computer that is to be connected wirelessly to the first device so that it can be controlled by the first device.

Here, for example, it is possible to realize the recognition of the coupling request via a stored preamble and/or a stored midamble, which was agreed accordingly when the two devices were configured. Such a method is available in mobile radio, for example, where it is used for channel estimation. In particular, a synchronization, i.e., a temporal alignment, of the devices can thereby be carried out.

According to one example embodiment of the present invention, it is provided that the first processing unit and/or the second processing unit are configured to use a convolutional code or block code in the structure-borne sound communication.

An advantage here is that such communication is more robust against external sources of interference. This makes the recognition of the mechanical connection and the corresponding actions based thereon more reliable and also increases the security of the system.

According to one example embodiment of the present invention, it is provided that the second processing unit is configured, after the determination of a mechanical connection, to detect a further structure-borne sound signal by means of the second structure-borne sound sensor and to compare it to a specified structure-borne sound signal, wherein the specified structure-borne sound signal is characteristic of a mechanical disconnection process of the first electronic device and the second electronic device, and to determine that the mechanical connection between the first electronic device and the second electronic device has been disconnected, if the further structure-borne sound signal and the specified structure-borne sound signal substantially match.

An advantage here is that, upon recognition of the disconnection of the mechanical connection between the electronic devices, a corresponding response of the second device can, for example, be carried out. Such a response may, for example, comprise blocking the second device and/or decoupling a radio connection between the second device and the first device.

### BRIEF DESCRIPTION OF THE DRAWINGS

FIG. 1 shows a first exemplary embodiment of a system according to the present invention for structure-borne sound communication within the system.

FIG. 2 shows a second exemplary embodiment of a system according to the present invention for structure-borne sound communication within the system.

FIG. 3 shows a third exemplary embodiment of a system according to the present invention for structure-borne sound communication within the system.

FIG. 4 shows a fourth exemplary embodiment of a system according to the present invention for structure-borne sound communication within the system.

### DETAILED DESCRIPTION OF EXAMPLE EMBODIMENTS

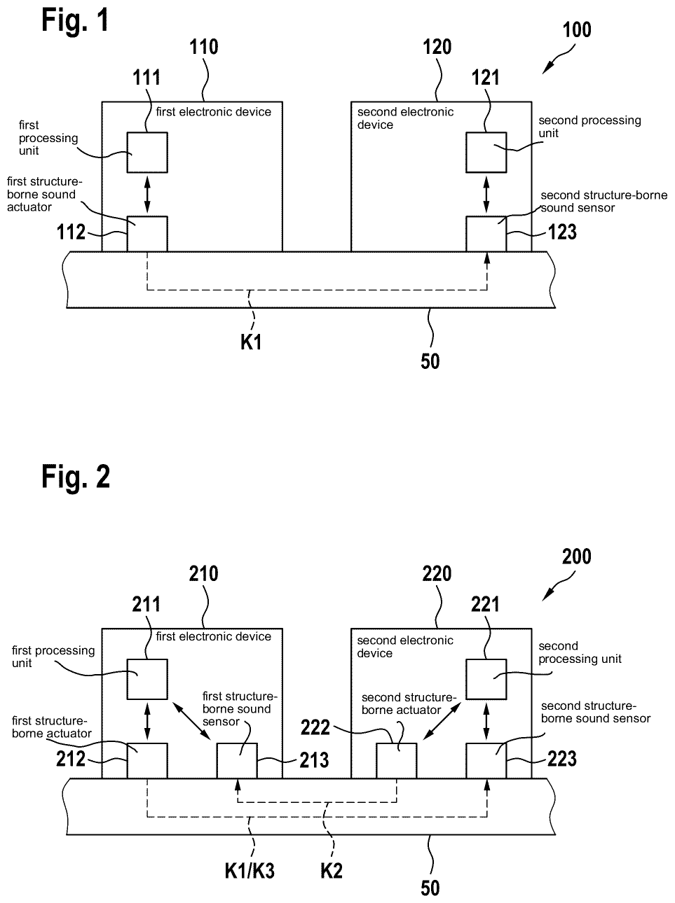

FIG. 1 shows a first exemplary embodiment of a system according to the present invention for structure-borne sound communication within the system.

A system 100 for structure-borne sound communication within the system 100 is shown. The system 100 comprises a first electronic device 110 and a second electronic device 120.

Here, the first electronic device 110 comprises at least a first processing unit 111 and a first structure-borne sound actuator 112, wherein the first processing unit 111 is configured to emit a first structure-borne sound signal K1 by means of the first structure-borne sound actuator 112.

Furthermore, the second electronic device 120 comprises at least a second processing unit 121 and a second structure-borne sound sensor 123, wherein the second processing unit 121 is configured to detect a structure-borne sound signal by means of the second structure-borne sound sensor 123 and, depending on the detected structure-borne sound signal, to determine whether a mechanical connection 50 is present between the first electronic device 110 and the second electronic device 120.

In particular, the second processing unit 121 can be configured to determine that a mechanical connection is present, if the detected structure-borne sound signal is substantially the emitted first structure-borne sound signal K1.

Here, additionally or alternatively, the first processing unit 111 can be configured to emit the first structure-borne sound signal K1 with at least one predetermined property, in particular a frequency range and/or an amplitude range and/or a bit sequence, wherein the second processing unit 121 can be configured to determine that a mechanical connection is present, if the detected structure-borne sound signal substantially has the predetermined property of the emitted first structure-borne sound signal K1 or only has a deviation in the property that is less than a specified maximum deviation.

Additionally or alternatively, the first processing unit 111 and the second processing unit 121 can be configured to carry out channel equalization for the structure-borne sound communication, in particular by means of an adaptive filter not shown in the figure.

Optionally, the first electronic device 110 may comprise a motion sensor not shown in the figure and/or an operating element not shown in the figure. Here, the first processing unit 111 can be configured to detect a motion of the first electronic device 110 by means of the motion sensor and to emit the first structure-borne sound signal K1 if a motion is detected, and/or to detect an operating signal by means of the operating element and to emit the first structure-borne sound signal K1 if an operating signal is detected.

In addition, the first processing unit 111 can additionally or alternatively be configured to add information to the first structure-borne sound signal K1, wherein the second processing unit 121 can accordingly be configured, upon detection of the first structure-borne sound signal K1, to evaluate the information of the detected first structure-borne sound signal K1.

Furthermore, a specified password can be stored in the first electronic device 110 and in the second electronic device 120 in each case and, in addition, a public key of a key pair can be stored in the first electronic device 110 and a private key of the key pair can be stored in the second electronic device 120. In this case, the first processing unit 111 can be configured to encrypt the specified password with the public key of the key pair and to add the encrypted password as information to the first structure-borne sound signal K1. Furthermore, the second processing unit 121 can be configured, upon detection of the first structure-borne sound signal K1, to decrypt the encrypted password with the private key of the key pair, and to compare the decrypted password to the specified password in the second electronic device 120, and to unlock the second electronic device 120 if the decrypted password and the specified password match.

In particular, the first processing unit 111 can here be configured to additionally add a first, current time stamp as information to the first structure-borne sound signal K1, and the second processing unit 121 can in particular be configured, upon detection of the first structure-borne sound signal K1, to additionally compare the received first time stamp to a second, current time stamp, and to unlock the second electronic device 120 if, in addition, the difference between the first time stamp and the second time stamp is less than a specified threshold value.

Furthermore, the first processing unit 111 and/or the second processing unit 121 can be configured to use a convolutional code or block code in the structure-borne sound communication. In addition, the second processing unit 121 can be configured, after the determination of a mechanical connection, to detect a further structure-borne sound signal by means of the second structure-borne sound sensor 123 and to compare it to a specified structure-borne sound signal, wherein the specified structure-borne sound signal is characteristic of a mechanical disconnection process of the first electronic device 110 and the second electronic device 120, and to determine that the mechanical connection between the first electronic device 110 and the second electronic device 120 has been disconnected, if the further structure-borne sound signal and the specified structure-borne sound signal substantially match.

FIG. 2 shows a second exemplary embodiment of a system according to the present invention for structure-borne sound communication within the system.

A system 200 is shown. Like the system 100 of FIG. 1, the system comprises a first electronic device 210 and a second electronic device 220. Here, the first electronic device 210 comprises at least a first processing unit 211 and a first structure-borne sound actuator 212. Furthermore, the second electronic device 220 comprises at least a second processing unit 221 and a second structure-borne sound sensor 223. Consequently, the system 200 can in principle also comprise the other embodiments of the system 100 disclosed in FIG. 1.

In addition, however, in the system 200, the first electronic device 210 comprises a first structure-borne sound sensor 213 and the second electronic device 220 comprises a second structure-borne sound actuator 222.

Furthermore, a public key of a key pair is stored in the first electronic device 210 and a private key of the key pair is stored in the second electronic device 220.

In addition, the second processing unit 221 is configured, after determining that a mechanical connection between the first device 210 and the second device 220 is present, to generate a random bit sequence and to emit by means of the second structure-borne sound actuator 222 a second structure-borne sound signal K2, to which the randomly generated bit sequence has been added as information.

Furthermore, the first processing unit 211 is configured to detect the second structure-borne sound signal K2 by means of the first structure-borne sound sensor 213, to encrypt with the public key the bit sequence contained in the second structure-borne sound signal K2, and to emit by means of the first structure-borne sound actuator 212 a third structure-borne sound signal K3, to which the encrypted bit sequence has been added as information.

Furthermore, the second processing unit 221 is configured to detect the third structure-borne sound signal K3 by means of the second structure-borne sound sensor 223, and to decrypt the encrypted bit sequence with the private key of the key pair, and to compare the decrypted bit sequence to the generated bit sequence, and to unlock the second electronic device 220 if the decrypted bit sequence and the randomly generated bit sequence match.

In particular, in addition, the first processing unit 211 can be configured to additionally add a first, current time stamp as information to the third structure-borne sound signal K3, and the second processing unit 221 can be configured to additionally compare the received, first time stamp to a second, current time stamp and to unlock the second electronic device 220 if, in addition, the difference between the first time stamp and the second time stamp is less than a specified threshold value.

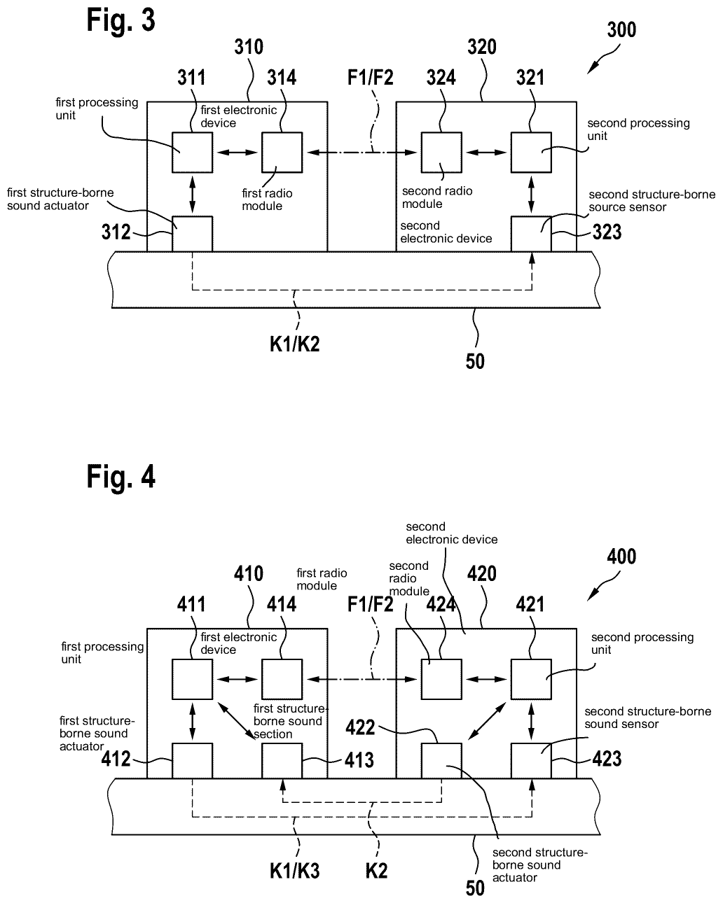

FIG. 3 shows a third exemplary embodiment of a system according to the present invention for structure-borne sound communication within the system.

A system 300 is shown. Like the system 100 of FIG. 1, the system comprises a first electronic device 310 and a second electronic device 320. Here, the first electronic device 310 comprises at least a first processing unit 311 and a first structure-borne sound actuator 312. Furthermore, the second electronic device 320 comprises at least a second processing unit 321 and a second structure-borne sound sensor 323. Consequently, the system 300 can in principle also comprise the other embodiments of the system 100 disclosed in FIG. 1.

In addition, however, in the system 300, the first electronic device 310 comprises a first radio module 314 and the second electronic device 320 comprises a second radio module 324. In addition, the first processing unit 311 is configured to add a coupling request and the radio module address of the first radio module 314 as information to the first structure-borne sound signal K1. Furthermore, the second processing unit 321 is configured, upon detection of the first structure-borne sound signal K1, to recognize the coupling request, to emit to the radio module address of the first radio module 314 by means of the second radio module 324 a first radio signal F1, which in turn contains a coupling request as information, and also to calculate a second pairing key.

Furthermore, the first processing unit 311 is configured to detect the first radio signal F1 by means of the first radio module 314 and, depending thereon, to calculate a first pairing key and to emit by means of the first structure-borne sound actuator 312 a second structure-borne sound signal K2, to which the first pairing key has been added as information.

In addition, the second processing unit 321 is configured to detect the second structure-borne sound signal K2 and, upon detection of the second structure-borne sound signal K2, to compare the first pairing key to the second pairing key and, if they match, to emit by means of the second radio module 324 a second radio signal F2, which confirms the coupling request of the first electronic device 310.

FIG. 4 shows a fourth exemplary embodiment of a system according to the present invention for structure-borne sound communication within the system.

A system 400 is shown. Like the system 100 of FIG. 1, the system comprises a first electronic device 410 and a second electronic device 420. Here, the first electronic device 410 comprises at least a first processing unit 411 and a first structure-borne sound actuator 412. Furthermore, the second electronic device 420 comprises at least a second processing unit 421 and a second structure-borne sound sensor 423. Consequently, the system 400 can in principle also comprise the other embodiments of the system 100 disclosed in FIG. 1.

In addition, however, in the system 400, the first electronic device 410 comprises a first structure-borne sound sensor 413 and the second electronic device 420 comprises a second structure-borne sound actuator 422, as is already the case in the system 200 according to FIG. 2. Consequently, the system 400 can in principle also comprise the other embodiments of the system 200 disclosed in FIG. 2.

In addition, however, in the system 400, the first electronic device 410 comprises a first radio module 414 and the second electronic device 420 comprises a second radio module 424, as is already the case in the system 300 according to FIG. 3. Consequently, the system 400 can in principle also comprise the other embodiments of the system 300 disclosed in FIG. 3.

Here, the first processing unit 411 is configured to add a first coupling request as information to the first structure-borne sound signal K1.

Furthermore, the second processing unit 421 is configured, upon detection of the first structure-borne sound signal K1, to recognize the first coupling request and, depending thereon, to emit by means of the second structure-borne sound actuator 422 a second structure-borne sound signal K2, which contains the radio module address of the second radio module 424 as information.

Furthermore, the first processing unit 411 is configured to detect the second structure-borne sound signal K2 by means of the first structure-borne sound sensor 413 and, upon detection of the second structure-borne sound signal K2, to emit to the radio module address of the second radio module 424 by means of the first radio module 414 a first radio signal F1, which contains a second coupling request as information, and also to calculate a first pairing key, and to emit by means of the first structure-borne sound actuator 412 a third structure-borne sound signal K3, which contains the first pairing key as information.

In addition, the second processing unit 412 is configured to detect the first radio signal F1 by means of the second radio module 424 and, depending thereon, to calculate a second pairing key, and to detect the third structure-borne sound signal K3 and, upon detection of the third structure-borne sound signal K3, to compare the first pairing key to the second pairing key and, if they match, to emit by means of the second radio module 424 a second radio signal F2, which confirms the second coupling request of the first electronic device 410.

1-14. (canceled)

15. A system for structure-borne sound communication within the system, the system comprising:
a first electronic device; and
a second electronic device;
wherein the first electronic device includes at least a first processing unit and a first structure-borne sound actuator, wherein the first processing unit is configured to emit a first structure-borne sound signal using the first structure-borne sound actuator, and wherein the second electronic device includes at least a second processing unit and a second structure-borne sound sensor, wherein the second processing unit is configured to detect a structure-borne sound signal using the second structure-borne sound sensor, and, depending on the detected structure-borne sound signal, to determine whether a mechanical connection is present between the first electronic device and the second electronic device.

16. The system according to claim 15, wherein the second processing unit is configured to determine that the mechanical connection is present if the detected structure-borne sound signal is substantially the emitted first structure-borne sound signal.

17. The system according to claim 15, wherein the first processing unit is configured to emit the first structure-borne sound signal with at least one predetermined property including a frequency range and/or an amplitude range and/or a bit sequence, wherein the second processing unit is configured to determine that the mechanical connection is present if the detected structure-borne sound signal substantially has the predetermined property of the emitted first structure-borne sound signal or only has a deviation in the predetermined property that is less than a specified maximum deviation.

18. The system according to claim 15, wherein the first processing unit and the second processing unit are configured to carry out channel equalization for the structure-borne sound communication using an adaptive filter.

19. The system according to claim 15, wherein the first electronic device includes a motion sensor and/or an operating element, wherein the first processing unit is configured to detect a motion of the first electronic device using the motion sensor and to emit the first structure-borne sound signal if the motion is detected, and/or to detect an operating signal using the operating element and to emit the first structure-borne sound signal if the operating signal is detected.

20. The system according to claim 15, wherein the first processing unit is configured to add information to the first structure-borne sound signal, wherein the second processing unit is configured to evaluate the information of the detected first structure-borne sound signal upon detection of the first structure-borne sound signal.

21. The system according to claim 15, wherein:
a specified password is stored in the first electronic device and in the second electronic device in each case, wherein, in addition, a public key of a key pair is stored in the first electronic device and a private key of the key pair is stored in the second electronic device,
the first processing unit is configured to encrypt the specified password with the public key of the key pair and to add the encrypted password as information to the first structure-borne sound signal,
the second processing unit is configured, upon detection of the first structure-borne sound signal, to decrypt the encrypted password with the private key of the key pair and to compare the decrypted password to the password specified in the second electronic device, and
the second processing unit is configured to unlock the second electronic device if the decrypted password and the specified password match.

22. The system according to claim 21, wherein:
the first processing unit is configured to add a first, current time stamp as information to the first structure-borne sound signal,
the second processing unit is configured to compare the received first time stamp to a second, current time stamp upon detection of the first structure-borne sound signal, and
the second processing unit is configured to unlock the second electronic device if, in addition, a difference between the first time stamp and the second time stamp is less than a specified threshold value.

23. The system according to claim 15, wherein:
the first electronic device includes a first structure-borne sound sensor, and the second electronic device includes a second structure-borne sound actuator, a public key of a key pair is stored in the first electronic device and a private key of the key pair is stored in the second electronic device,
the second processing unit is configured, after determining that a mechanical connection is present between the first device and the second device, to generate a random bit sequence and to emit using the second structure-borne sound actuator a second structure-borne sound signal, to which the generated random bit sequence has been added as information,
the first processing unit is configured to detect the second structure-borne sound signal using the first structure-borne sound sensor, to encrypt with the public key the bit sequence contained in the second structure-borne sound signal, and to emit using the first structure-borne sound actuator a third structure-borne sound signal, to which the encrypted bit sequence has been added as information,
the second processing unit is configured to detect the third structure-borne sound signal using the second structure-borne sound sensor, and to decrypt the encrypted bit sequence with the private key of the key pair, and to compare the decrypted bit sequence to the generated random bit sequence,
the second processing unit is configured to unlock the second electronic device if the decrypted bit sequence and the generated random bit sequence match.

24. The system according to claim 23, wherein:
the first processing unit is configured to additionally add a first, current time stamp as information to the third structure-borne sound signal,
the second processing unit is configured to additionally compare the received first time stamp to a second, current time stamp, and
the second processing unit is configured to unlock the second electronic device if, in addition, a difference between the first time stamp and the second time stamp is less than a specified threshold value.

25. The system according to claim 15, wherein:
the first electronic device includes a first radio module, and the second electronic device includes a second radio module,
the first processing unit is configured to add a coupling request and a radio module address of the first radio module as information to the first structure-borne sound signal,
the second processing unit is configured, upon detection of the first structure-borne sound signal, to recognize the coupling request, to emit to the radio module address of the first radio module using the second radio module a first radio signal which contains a coupling request as information, and also to calculate a second pairing key,
the first processing unit is configured to detect the first radio signal using the first radio module, and, depending on the first radio signal, to calculate a first pairing key and to emit using the first structure-borne sound actuator a second structure-borne sound signal, to which the first pairing key has been added as information,
the second processing unit is configured to detect the second structure-borne sound signal, and, upon detection of the second structure-borne sound signal, to compare the first pairing key to the second pairing key and, if they match, to emit, using the second radio module, a second radio signal, which confirms the coupling request of the first electronic device.

26. The system according to claim 15, wherein:
the first electronic device includes a first structure-borne sound sensor and a first radio module, and the second electronic device includes a second structure-borne sound actuator and a second radio module,
the first processing unit is configured to add a first coupling request as information to the first structure-borne sound signal,
the second processing unit is configured, upon detection of the first structure-borne sound signal, to recognize the first coupling request and, depending thereon, to emit using the second structure-borne sound actuator a second structure-borne sound signal, which contains a radio module address of the second radio module as information,
the first processing unit is configured to detect the second structure-borne sound signal using the first structure-borne sound sensor and, upon detection of the second structure-borne sound signal, to emit to the radio module address of the second radio module using the first radio module a first radio signal, which contains a second coupling request as information, and also to calculate a first pairing key, and to emit using the first structure-borne sound actuator a third structure-borne sound signal, which contains the first pairing key as information, and
the second processing unit is configured to detect the first radio signal using the second radio module and, depending on the first radio signal, to calculate a second pairing key and to detect the third structure-borne sound signal and, upon detection of the third structure-borne sound signal to compare the first pairing key to the second pairing key and, if they match, to emit using the second radio module a second radio signal, which confirms the second coupling request of the first electronic device.

27. The system according to claim 15, wherein the first processing unit and/or the second processing unit are configured to use a convolutional code or block code in the structure-borne sound communication.

28. The system according to claim 15, wherein the second processing unit is configured, after the determination of the mechanical connection, to detect a further structure-borne sound signal using the second structure-borne sound sensor and to compare the further structure-borne sound signal to a specified structure-borne sound signal, wherein the specified structure-borne sound signal is characteristic of a mechanical disconnection process of the first electronic device and the second electronic device, and to determine that the mechanical connection between the first electronic device and the second electronic device has been disconnected, if the further structure-borne sound signal and the specified structure-borne sound signal substantially match.
